(19) United States
(12) Patent Application Publication
(10) Pub. No.: US 2008/0024520 A1
(43) Pub. Date: Jan. 31, 2008

(54) Digital image file transmission

(76) Inventor: Michael L. Rudd, Ft. Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/493,287

(22) Filed: Jul. 26, 2006

(51) Int. Cl. G09G 5/00

(52) U.S. Cl. 345/619

(57) ABSTRACT

At a device of a sending user, the following is performed. A thumbnail image and a smaller-sized image are generated for each digital image file. The smaller-sized image file is smaller in size than the digital image file but greater in size than the thumbnail image file for the digital image file. The thumbnail image file for each digital image file is transmitted to a computing device of each of one or more receiving users, in a peer-to-peer manner, for display to each receiving user. The smaller-sized image file for each digital image file is transmitted to a remote storage repository accessible by each receiving user for storage at the remote storage repository.

### BACKGROUND

Digital cameras are becoming more popular than traditional film cameras for consumers to snap photos. Digital cameras generate digital image files, which can be viewed on a variety of different devices, and also can be shared with others, without necessarily having to order prints as with traditional film cameras. Existing approaches to sharing digital image files include email dissemination, peer-to-peer transmission, and uploading to a hosted image-sharing site. However, each of these approaches has disadvantages, which prevent consumers from effectively and easily sharing their digital image files with others.

### BRIEF DESCRIPTION OF THE DRAWINGS

FIG. 1 is a diagram of a system, according to an embodiment of the invention.

FIGS. 2 and 3 are diagrams of representative graphical user interfaces (GUI's) that can be used in conjunction with the system of FIG. 1, according to different embodiments of the invention.

FIGS. 4A, 4B, and 4C are flowcharts of a method that can be performed in relation to the system of FIG. 1, according to an embodiment of the invention.

### DETAILED DESCRIPTION OF THE DRAWINGS

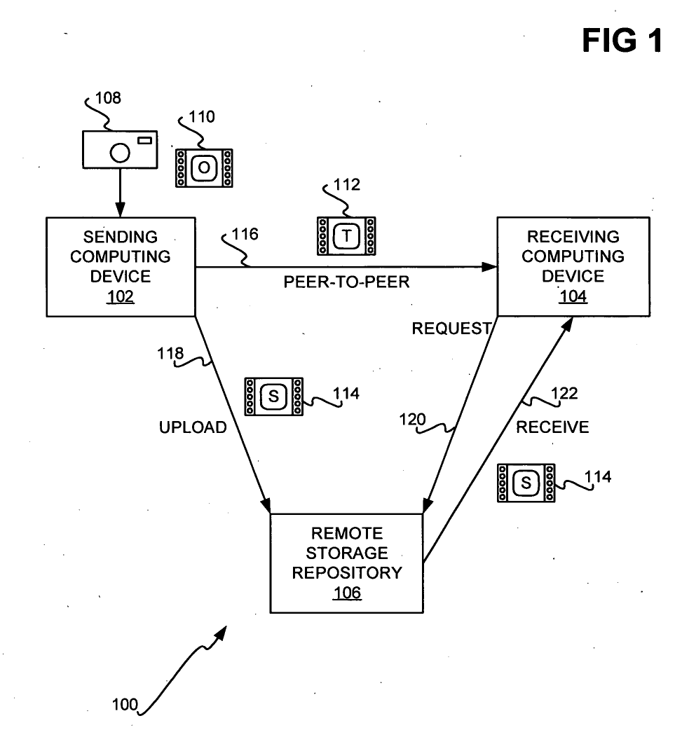

FIG. 1 shows a system 100, according to an embodiment of the invention. Basic functionality and operation of an embodiment of the invention is particularly described in relation to the system 100. More advanced functionality and operation of an embodiment of the invention may further be implemented in relation to the system 100, but is specifically described in relation to a method described later in the detailed description.

The system 100 includes a sending computing device 102, a receiving computing device 104, and a remote storage repository 106. There may be more than one of the computing devices 102 and 104, but just one of each is depicted in FIG. 1 for illustrative clarity and convenience. Each of the computing devices 102 and 104 may be a laptop or desktop computer, or another type of device that has some computing functionality by virtue of an included processor or other type of component.

It is noted that whereas the computing devices 102 and 104 are specifically denoted as being a sending device and a receiving device, respectively, each of these devices may further be able to perform the functionality of the other. Thus, the computing device 104 may further perform sending device functionality, as is described herein, and the computing device 102 may further perform receiving device functionality, as is described herein. However, for descriptive clarity and convenience, the sending device functionality is ascribed as to the computing device 102, and the receiving device functionality is ascribed to the computing device 104.

The remote storage repository 106 may be or include one or more photo-sharing web site servers. The computing devices 102 and 104 are communicatively interconnected with one another, as well as with the remote storage repository 106, via one or more networks, such as the Internet. The remote storage repository 106 is remote in that it is not located at the same physical place as the computing devices 102 and 104.

A digital camera device 108 may be communicatively connected to the sending computing device 102. The sending computing device 102 may download one or more digital image files 110 that were generated by the digital camera device 108. Alternatively, the digital image files 110 may be received, generated, or stored by the sending computing device 102 in a way that does not involve the digital camera device 108.

The digital image files 110 are denoted by the letter “O” in FIG. 1 to indicate that they are original resolution digital image files. Typically, as generated by a digital camera device such as the device 108, these original resolution digital image files 110 have a relatively high resolution, such as two, three, four, five, or more mega pixels per image. As such, each of the digital image files 110 is relatively large in size in terms of file size. The digital image files 110 may be stored in a variety of different image file formats, such as typically JPG, or TIF, or another image file format.

The sending computing device 102 generates two other types of image files from each of the digital image files 110. First, the sending computing device 102 generates thumbnail image files 112, denoted by the letter “T” in FIG. 1, for the digital image files 110. Each of the digital image files 110 thus has a corresponding thumbnail image file 112. A thumbnail image file is a miniature representation of a corresponding digital image file that is used to identify the digital image file. That is, the image of the thumbnail image file is the same as its corresponding digital image file, but only smaller in size, with less resolution. For instance, at its full resolution, a thumbnail image file may only be one or two inches along its width or length when displayed. It is noted that the size of the thumbnail image file that is created may be configurable by both the sending user and the receiving user, and then negotiated by the sending computing device 102 and the receiving computing device 104.

Second, the sending computing device 102 generates smaller-sized image files 114, denoted by the letter “S” in FIG. 1, for the digital image files 110. Each of the digital image files 110 thus has a corresponding smaller-sized image file 114. A smaller-sized image file may be considered a smaller version of a corresponding digital image file, but which is still a useful size for viewing and/or printing at standard printing sizes, such as up to eight-by-ten inches. More specifically, the image of the smaller-sized image file is the same as its corresponding digital image file, but only smaller, with less resolution, and smaller in size, but still greater in size, with more resolution, than the thumbnail image file corresponding to the same digital image file. For instance, at its full resolution, a smaller-sized image file may correspond to eight-by-ten inches when printed. (As used herein, size refers to the file size of an image file, such as which may be measured in bytes, for instance.)

Thus, the purpose of a thumbnail image file is to enable a user to quickly determine whether the image of the thumbnail image file is of interest. If the image is of interest, the user can retrieve the smaller-sized image file to view a larger version of the image, without having to retrieve the full, original-resolution digital image file itself. The purpose of a smaller-sized image file is thus to enable a user to view and print a larger version of an image, where such viewing and printing does not require the full, original-resolution digital image file for the image in question, which can be significantly larger in size and/or in resolution than the smaller-sized image file.

The sending computing device 102 transmits the thumbnail image files 112 to the receiving computing device 104 in a peer-to-peer manner, as indicated by the arrow 116. Peer-to-peer communication means that two computing devices exchange data with one another, where the data is not intended for indefinite storage on any intermediate computing device. For instance, where both the computing devices 102 and 104 are connected to the Internet, transmitting data from the former device to the latter device will likely result in temporary storage of the data on one or more intermediary server computing devices. However, peer-to-peer communication means that this data is not intended for permanent storage on any of these intermediary devices, and these intermediary devices are in any case not later accessible by the devices 102 and 104 for subsequent retrieval of this data therefrom. A peer-to-peer topology can be contrasted with a client-server topology, in which a client may transmit data to a server for indefinite storage thereon, so that other clients may receive the data from this server.

The sending computing device 102 transmits, or uploads, the smaller-sized image files 114 to the remote storage repository 106, as indicated by the arrow 118. This transmission is more akin to client-server communication, where the sending computing device 102 is a client, and sends data to the remote storage repository 106, which acts as a server. The remote storage repository 106 stores the smaller-sized image files 114 for an indefinite period of time. Different strategies for deleting these smaller-sized image files 114 from the remote storage repository 106 are described in relation to a method, later in the detailed description.

Desirably upon receipt of the thumbnail image files 112, the receiving computing device 104 substantially immediately displays the thumbnail image files 112 to a receiving user. The receiving user can thus decide, by viewing the miniature images of the thumbnail image files 112, which of the images are of particular interest. Upon making this decision, the receiving user transmits a request, via the receiving computing device 104, to the remote storage repository 106, for the smaller-sized image files 114 of one or more of the thumbnail image files 112, as indicated by the arrow 120. In response, the remote storage repository 106 transmits the smaller-sized image files 114 for the selected thumbnail image files 112 in question (i.e., and not necessarily for all of the thumbnail image files 112) to the receiving computing device 104, which receives them, as indicated by the arrow 122. Alternatively or additionally, upon selecting a desired thumbnail image file, the receiving user, via the receiving computing device 104, may be automatically or otherwise logged onto a web site maintained by the storage repository 106, such that the receiving user views the smaller-sized image file for the desired thumbnail file in question at this web site, instead of or addition to having it downloaded to the device 104. This alternative is referred to subsequently herein in shorthand as the “launch to view” option.

The receiving computing device 104 then stores the smaller-sized image files 114 that have been received for the receiving user-selected thumbnail image files 112. The receiving user may view the smaller-sized image files 114 received. The receiving user may further print the smaller-sized image files 114 received. The receiving user may in addition perform other functionality or actions in relation to the smaller-sized image files 114 that have been received. For instance, the receiving user may print the smaller-sized image files 114 from the web site where the “launch to view” option has been selected.

The basic functionality and operation of an embodiment of the invention as has been described in relation to FIG. 1 provides for advantages over the prior art. The receiving user at the receiving computing device 104 substantially immediately receives and views all the thumbnail image files 112 sent by a sending user at the sending computing device 102. Because the thumbnail image files 112 are very small in size, not much bandwidth is consumed during this communication, nor is a large amount of storage space needed at the receiving computing device 104. The smaller-sized image files 114 are sent by the sending computing device 102 to just one recipient, the remote storage repository 106, as opposed to having to send multiple copies of the same image files 114 to multiple recipients, such as multiple receiving computing devices like the receiving computing device 104.

Furthermore, the receiving user requests and receives the smaller-sized image files 114 of just those images that are of interest to him or her. The receiving computing device 104 receives these smaller-sized image files 114 from the remote storage repository 106. Therefore, the receiving computing device 104 only takes the time (i.e., bandwidth) and storage to retrieve the desired smaller-sized image files 114, and not necessarily all of the smaller-sized image files 114, which may include images for which the receiving user does not care. In addition, the remote storage repository 106 transmits these smaller-sized image files 114 to each receiving computing device. As such, the sending computing device 102 does not have to be responsible for sending these smaller-sized image files 114, which can require significant time to transmit if there are a number of receiving computing devices requesting such files.

Therefore, at least some embodiments of the invention enable receiving users to receive near-immediate notification of images that they may have interest in, and do not have to download or otherwise retrieve all the smaller-sized image files 114, but rather just download or otherwise retrieve just the smaller-sized image files 114 of interest. Furthermore, at least some embodiments of the invention do not require either the sending user at the sending computing device 102 or the receiving user at the receiving computing device 104 to manage storage of the smaller-sized image files 114. If one or more of the smaller-sized image files 114 are inadvertently deleted, this is not a problem, because the remote storage repository 106 ultimately stores the smaller-sized image files 114 for an indefinite period of time.

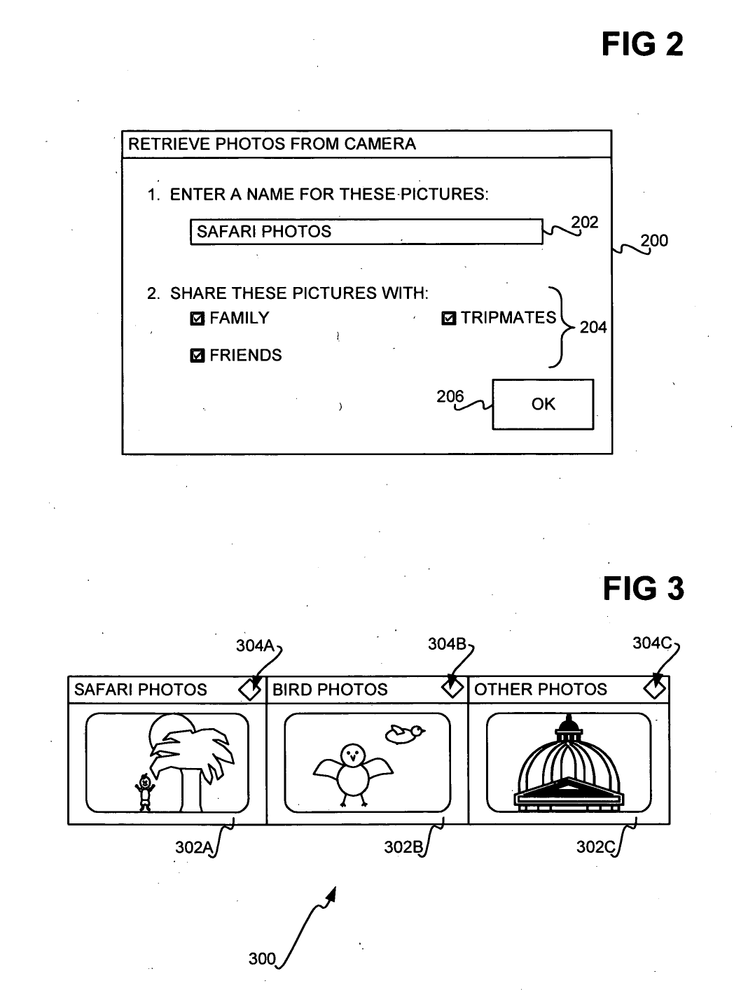

FIG. 2 shows a graphical user interface (GUI) 200 by which a sending user at the sending computing device 102 can send the thumbnail image files 112 to the receiving computing device 104 and the smaller-sized image files 114 to the remote storage repository 106, according to an embodiment of the invention. The GUI 200 includes a box 202 in which the sending user can name the group of digital image files 110 that have been retrieved from the digital camera device 108. The GUI 200 also includes a number of checkboxes 204 corresponding to groups of receiving users to which the sending user can cause the thumbnail image files 112 to be sent.

When the user selects the OK button 206, the sending computing device 102 generates the thumbnail image files 112 and the smaller-sized image files 114 from the digital image files 110 retrieved from the digital camera device 108. The thumbnail image files 112 are then sent to the receiving computing device of each receiving user within the selected groups, such as the receiving computing device 104. The smaller-sized image filed 114 are sent to the remote storage repository 106 at the same time. The GUI 200 can include other elements and aspects besides those depicted in FIG. 2.

FIG. 3 shows a GUI 300 by which a receiving user at the receiving computing device 104 can view the thumbnail image files 112 and select one or more of the thumbnail image files 112 to retrieve the corresponding smaller-sized image files 114, according to an embodiment of the invention. For each different group of the digital image files 110, there is a corresponding pane 302A, 302B, or 302C, which are collectively referred to as the panes 302. Within each of the panes 302 one of the thumbnail image files 112 of a corresponding group is displayed.

In one embodiment, the user may select the element 304A, 304B, or 304C within a given pane, which are collectively referred to as the elements 304, to cause all the thumbnail image files 112 of the group in question to be displayed. Alternative manners by which the different thumbnail image files 112 within each group can be navigated are also amenable to embodiments of the invention. By selecting, such as clicking on, a desired thumbnail image file 112, the user causes the receiving computing device 104 to retrieve the corresponding smaller-sized image file 114 from the remote storage repository 106 for storage on and display by the receiving computing device 104. In addition, or alternatively, by selecting a desired thumbnail image file 112, the user may initiate the “launch to view” option that has been described.

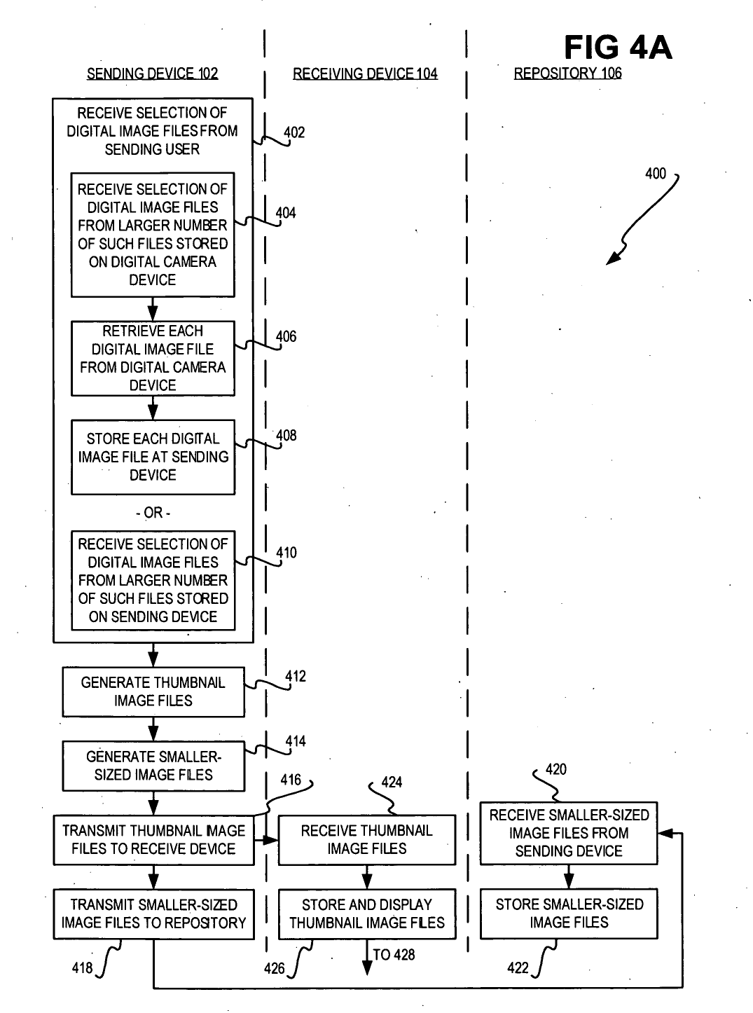

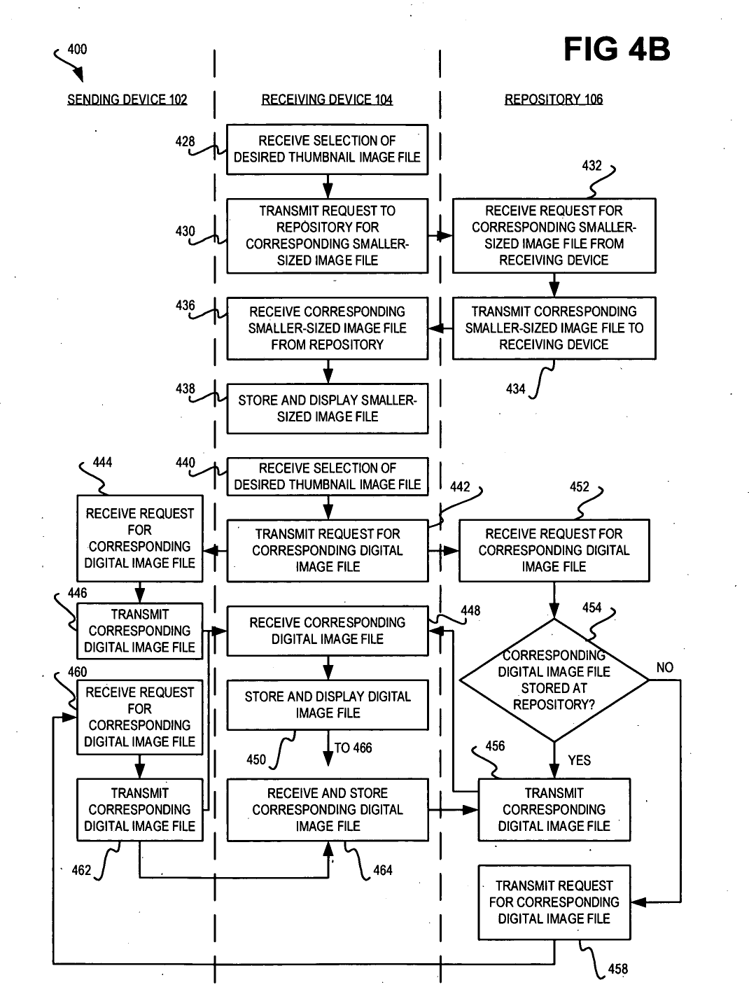

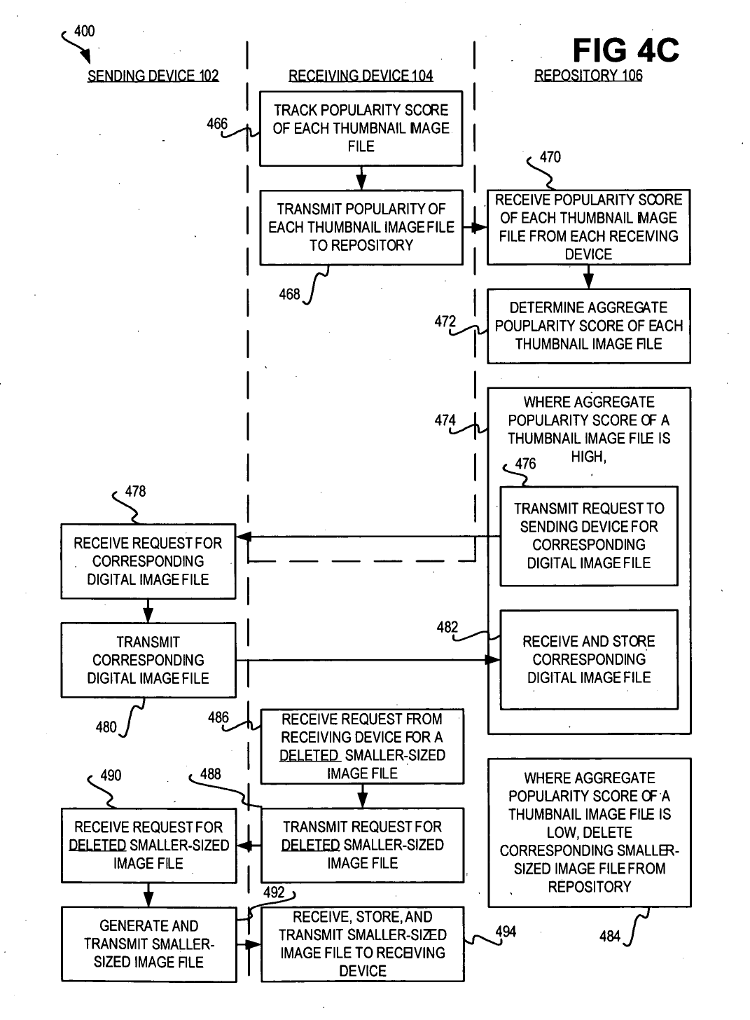

FIGS. 4A, 4B, and 4C show a method 400 that can be performed in relation to the system 100, according to an embodiment of the invention. Different parts of the method 400 are performed by the computing device 102 of the sending user, which is also referred to as the sending device, by the computing device 104 of the receiving user, which is also referred to as the receiving device, and by the remote storage repository 106, which is also referred to simply as the repository. The devices 102 and 104 do not necessarily have to be computing devices per se, but can be digital camera devices, as well as other types of devices.

Referring first to FIG. 4A, the sending device 102 receives, from a sending user at the device 102, selection of the digital image files 110 (402). For instance, in one embodiment, the digital image files 110 may be selected from a larger number of such digital image files stored on the digital camera device 108 (404). In such instance, each digital image file selected is retrieved from the digital camera device (406), and stored at the sending device 102 (408). In another embodiment, the digital image files 110 may be selected from a larger number of such digital image files stored on the sending device 102 already (410).

Once the digital image files 110 have been selected, the sending device 102 generates the thumbnail image files 112 (412) and the smaller-sized image files 114 (414), as has been described. The thumbnail image files 112 are transmitted in a peer-to-peer manner to the receiving device 104 (416), whereas the smaller-sized image files are transmitted to the repository 106 (418). The repository 106 receives the smaller-sized image files 114 (42), and stores them (422). The receiving device 104 receives the thumbnail image files 112 (424), and stores and displays them (426).

Referring next to FIG. 4B, at some point the receiving user selects a desired thumbnail image file at the receiving device 104 for which to receive a corresponding smaller-sized image file (428). That is, it is said that the receiving device 104 receives selection of a desired thumbnail image file from the receiving user. The receiving device 104 transmits a request to the repository 106 for the corresponding smaller-sized image file (430). The repository 106 receives this request (432), and transmits the corresponding smaller-sized image file to the receiving device 104 (434). The receiving device 104 receives the corresponding smaller-sized image file from the repository 106 (436), and stores and displays this smaller-sized image file (438). In addition to or in alternative of parts 430, 432, 343, 436, and 438, the “launch to view” option that has been described above may be initiated.

Furthermore, the receiving user may at some point select a desired thumbnail image file at the receiving device 104 for which to receive a corresponding digital image file (440). That is, the receiving device 104 receives selection of a desired thumbnail image from the receiving user. The difference between parts 440 and 428 is that in the former, the receiving user is requesting the smaller-sized image file corresponding to the desired thumbnail image file. By comparison, in the latter, the receiving user is requesting the original digital image file corresponding to the desired thumbnail image file.

The receiving device 104 transmits the request for the corresponding digital image file (442). In one embodiment, this request is transmitted to the sending device 102, which receives the request (444), and transmits the corresponding digital image file to the receiving device 104 (446), such as in a peer-to-peer manner. The receiving device 104 receives this digital image file (448), and stores and displays it (450).

In another embodiment, however, the request for the corresponding digital image file is transmitted from the receiving device 104 to the repository 106, which receives the request (452). The repository 106 determines whether the corresponding digital image file is stored at the repository 106 (454), where such storage may be achieved as is described later in relation to the method 400. If the repository 106 has stored this digital image file, then the repository transmits the corresponding digital image file to the receiving device 104 (456). As before, the receiving device 104 receives this digital image file (448), and stores and displays it (450).

However, if the repository has not stored the corresponding digital image file, then the repository transmits a request for this digital image file to the sending device 102 (458). The sending device 102 receives the request (460), and transmits the corresponding digital image file (462), assuming the sending device still has the original digital image file in question. In one embodiment, the sending device 102 transmits the corresponding digital image file directly to the receiving device 104, which as before receives this digital image file (448), and stores and displays it (450).

However, in another embodiment, the sending device 102 transmits the corresponding digital image file requested to the repository 106, which receives and stores this digital image file (464). The repository 106 then transmits the digital image file to the receiving device 104 (456). As before, the receiving device 104 receives this digital image file (448), and stores and displays it (450).

Referring finally to FIG. 4C, the receiving device 104, as well as every other receiving device to which the thumbnail image files 112 have been transmitted, may track the popularity score of each thumbnail image file (466). The popularity score of a given thumbnail image file, and thus of the corresponding digital image file, may be the number of times the receiving user has viewed the thumbnail image file at the receiving device 104, or at the remote storage repository 106, by, for instance, having logged onto the repository 106 the Internet. The popularity score may further be the number of times the sending user has viewed the thumbnail image file at the sending device 102, or at the remote storage 106. Viewing the thumbnail image file in this respect can further mean viewing the smaller-sized image file and/or the digital image file corresponding to this thumbnail image file. The popularity score may additionally, or alternatively, be a rating assigned to the thumbnail image file (and thus to the corresponding digital image file and/or the corresponding smaller-sized image file) by the receiving user and/or by the sending user. For instance, the receiving user as well as the sending user may be able to rate each image on a scale, such as from one to five.

Thereafter, at some point and/or periodically, the receiving device 104 transmits the popularity score of each thumbnail image file to the repository 106 (468). The repository 106 receives the popularity score of each thumbnail image file from each receiving device, such as the receiving device 104 (470), as well as from the sending device 102 in one embodiment. The repository 106 then determines an aggregate popularity score of each thumbnail image file (472), and thus of each digital image file, based on the popularity scores received from the receiving and/or sending devices, and/or on the popularity scores that have been entered directly at the repository 106 by receiving and/or sending users logging onto the repository 106, such as over the Internet. The aggregate popularity score of each thumbnail image file may be the average popularity score in one embodiment, or may be determined in another manner as well.

Different actions can be performed in relation to the digital image file to which a thumbnail image file corresponds based on this aggregate popularity score. For instance, where the aggregate popularity score of a thumbnail image file is high (474), such as by being one of the highest number aggregate popularity scores, or such as by being greater than a threshold, the following can be performed. The repository 106 transmits a request to the sending device 102 for the original digital image file corresponding to the thumbnail image file in question (476). The sending device 102 receives this request (478), and in response transmits the corresponding original digital image file to the repository 106 (480), assuming it still has the original digital image file in question. The repository 106 receives and stores this original digital image file (482). Thus, where the aggregate popularity score is high, the repository 106 stores the original digital image file, and not just the smaller-sized image file, for a given image.

As another example, where the aggregate popularity score of a thumbnail image is low, such as by being one of the lowest aggregate popularity scores, or such as by being less than a threshold, the corresponding smaller-sized image file may be deleted from the repository 106 (484). In this way, smaller-sized image files are periodically deleted in an intelligent way, in that less popular smaller-sized image files may be automatically deleted after a given length of time if their aggregate popularity scores are low. Other approaches can also be followed to periodically delete smaller-sized image files from the repository 106.

However, where a smaller-sized image file has been deleted from the repository 106, the repository 106 may later receive a request from the receiving device 104 for this deleted, smaller-sized image file (486). For instance, the receiving device 104 may make the request as in part 430 of FIG. 4B. Because the smaller-sized image file in question has been deleted from the repository 106, the repository 106 transmits a request for the deleted smaller-sized image file to the sending device 102 (488). The sending device 102 receives the request for this deleted smaller-sized image file (490), and assuming that it still has the corresponding original digital image file, locates this original digital image file, generates the smaller-sized image file requested and transmits this smaller-sized image file to the repository 106 (492). The repository 106 receives and stores the smaller-sized image file, and then transmits it to the receiving device 104 (494). The receiving device 104 may then store and display the smaller-sized image file, as in part 438 of FIG. 4A. The repository 106 may reset some type of internal timer so that it keeps this newly restored, albeit low-rated, image file for a period of time before again deleting it.

We claim:

1. A method comprising, at a device of a sending user:
generating a thumbnail image file for each of one or more digital image files;
generating a smaller-sized image file for each digital image file, the smaller-sized image file being smaller in size than, the digital image file but greater in size than the thumbnail image file for the digital image file;
transmitting the thumbnail image file for each digital image file to a computing device of each of one or more receiving users, in a peer-to-peer manner, for display to each receiving user; and,
transmitting the smaller-sized image file for each digital image file to a remote storage repository accessible by each receiving user for storage at the remote storage repository.

2. The method of claim 1, further comprising initially receiving selection of the digital image files by the sending user from a larger plurality of digital image files stored on the device of the sending user.

3. The method of claim 1, further comprising initially receiving selection of the digital image files by the sending user from a larger plurality of digital image files stored on a digital camera device communicatively connected to the device of the sending user.

4. The method of claim 1, wherein transmitting the thumbnail image file for each digital image file to the computing device of each receiving user in a peer-to-peer manner comprises transmitting the thumbnail image file for each digital image file to the computing device of each receiving user in a peer-to-peer manner such that during transmission the thumbnail image file is not intended for indefinite storage on any computing device except for the device of the sending user and the computing device of each receiving user.

5. The method of claim 1, further comprising:
at the computing device of one of the receiving users,
receiving selection of a desired thumbnail image file received from the sending user;
in response, transmitting a request to the remote storage repository to receive the smaller-sized image file for the digital image file corresponding to the thumbnail image file;
receiving the smaller-sized image file for the digital image file corresponding to the thumbnail image file from the remote storage repository; and,
storing the smaller-sized image file for the digital image file corresponding to the thumbnail image file.

6. The method of claim 1, further comprising:
at the computing device of one of the receiving users,
receiving selection of a desired thumbnail image file received from the sending user;
in response, transmitting a request to receive the digital image file corresponding to the thumbnail image file;
receiving the digital image file corresponding to the thumbnail image file; and,
storing the digital image file corresponding to the thumbnail image file.

7. The method of claim 6, wherein the request is transmitted to the device of the sending user, and the digital image file is received from the device of the sending user.

8. The method of claim 6, wherein the request is transmitted to the remote storage repository, the method further comprising:
at the remote storage repository,
receiving the request to receive the digital image file corresponding to the thumbnail image file from the computing device of the receiving user;
determining whether the digital image file is stored at the remote storage repository; and,
where the digital image file is stored at the remote storage repository, transmitting the digital image file corresponding to the thumbnail image file to the computing device of the receiving user.

9. The method of claim 8, further comprising:
at the remote storage repository,
where the digital image file is not stored at the remote storage repository, performing one or more of:
transmitting a request to the device of the sending user to transmit the digital image file directly to the computing device of the receiving user; and,
transmitting a request to the device of the sending user to transmit the digital image file to the remote storage repository for storage at the remote storage repository.

10. The method of claim 1, further comprising:
at the computing device of each of one or more of the receiving users,
tracking a popularity score of each thumbnail image file in relation to the receiving user; and,
transmitting the popularity score of each thumbnail image file to the remote storage repository.

11. The method of claim 10, wherein the popularity score is one or more of: a number of times the receiving user has viewed the thumbnail image file at the computing device and/or at the remote storage repository; and, a rating of the thumbnail image file by the receiving user.

12. The method of claim 10, further comprising:
at the remote storage repository,
for each thumbnail image file,
receiving from the computing device of each of one or more of the receiving users the popularity score of the thumbnail image file;
determining an aggregate popularity score of the thumbnail image file based on the popularity scores of the thumbnail image file received; and,
performing an action in relation to the digital image file to which the thumbnail image file corresponds based on the aggregate popularity score.

13. The method of claim 12, wherein performing the action in relation to the digital image file to which the thumbnail image file corresponds based on the aggregate popularity score comprises, where the aggregate popularity score is high:
transmitting a request to the device of the sending user for the digital image file to which the smaller-sized image file for the thumbnail image file corresponds;
receiving the digital image file to which the smaller-sized image file for the thumbnail image file corresponds from the device of the sending user; and,
storing the digital image file at the remote storage repository.

14. The method of claim 12, wherein performing the action in relation to the digital image file to which the thumbnail image file corresponds based on the aggregate popularity score comprises, where the aggregate popularity score is low:
deleting the smaller-sized image file for the digital image file to which the thumbnail image file corresponds from the remote storage repository;
where in response to receiving a request for the smaller-sized image file for the digital image file to which the thumbnail image file corresponds from the computing device of one of the receiving users,
transmitting a request to the device of the sending user for the smaller-sized image file for the digital image file to which the thumbnail image file corresponds;
receiving the smaller-sized image file for the digital image file to which the thumbnail image file corresponds from the device of the sending user;
storing the smaller-sized image file for the digital image file to which the thumbnail image file corresponds at the remote storage repository; and,
transmitting the smaller-sized image file for the digital image file to which the thumbnail image file corresponds to the computing device of the receiving user.

15. A method comprising, at a computing device of a receiving user:
receiving one or more thumbnail image files from a device of a sending user in a peer-to-peer manner, each thumbnail image file corresponding to a digital image file at the device of the sending user;
displaying the thumbnail image files for viewing by the receiving user;
receiving from the receiving user a request for a smaller-sized image file of a digital image file to which a selected thumbnail image file corresponds, the smaller-sized image file being smaller in size than the digital image file but greater in size than the selected thumbnail image file;
transmitting the request for the smaller-sized image file of the digital image file to which the selected thumbnail image file corresponds to a remote storage repository;
receiving the smaller-sized image file of the digital image file to which the selected thumbnail image file corresponds from the remote storage repository, the remote storage repository previously receiving the smaller-sized image file from the device of the sending user; and,
displaying the smaller-sized image file of the digital image file to which the selected thumbnail image file corresponds for viewing by the receiving user.

16. The method of claim 15, further comprising:
transmitting a request for the digital image file to which a selected thumbnail image file corresponds to one of the device of the sending user and the remote storage repository;
receiving the digital image file to which the selected thumbnail image file corresponds from one of the device of the sending user and the remote storage repository; and,
storing the digital image file at the computing device of the receiving user.

17. The method of claim 15, further comprising:
tracking a popularity score of each thumbnail image file in relation to the receiving user; and,
transmitting the popularity score of each thumbnail image file to the remote storage repository.

18. The method of claim 17, wherein the popularity score is one or more of: a number of times the receiving user has viewed the thumbnail image file at the computing device and/or at the remote storage repository; and, a rating of the thumbnail image file by the receiving user.

19. The method of claim 15, wherein receiving the thumbnail image files from the device of the sending user in a peer-to-peer manner comprises receiving the thumbnail image files from the device of the sending user in a peer-to-peer manner such that during transmission the thumbnail image files are not intended for indefinite storage on any computing device except for the device of the sending user and the computing device of the receiving user.

20. A computer-readable medium having a computer program stored thereon to perform a method in relation to a device of a sending user comprising:
receiving selection of one or more digital image files by the sending user;
generating a thumbnail image file for each digital image file;
generating a smaller-sized image file for each digital image file, the smaller-sized image file being smaller in size than the digital image file but greater in size than the thumbnail image file for the digital image file;
transmitting the thumbnail image file for each digital image file to a computing device of each of one or more receiving users, in a peer-to-peer manner, for display to each receiving user;
transmitting the smaller-sized image file for each digital image file to a remote storage repository accessible by each receiving user for storage at the remote storage repository; and,
in response to a request for one of the digital image files from one of the remote storage repository and the computing device of one of the receiving users, transmitting the digital image file to one of the remote storage repository and the computing device of the one of the receiving users.
